(19) United States
(12) Patent Application Publication
(10) Pub. No.: US 2008/0131235 A1
(43) Pub. Date: Jun. 5, 2008

(54) MECHANICAL RECLAIM SYSTEMS WITH AERATION AND METHODS FOR USE

(75) Inventors: Wyn D. Laidig, Mishawaka, IN (US); Thomas W. Hedrick, Sikeston, MO (US)

Correspondence Address: WORKMAN NYDEGGER, 60 EAST SOUTH TEMPLE, 1000 EAGLE GATE TOWER, SALT LAKE CITY, UT, 84111, US

(73) Assignees: Dome Technology, LLC, Idaho Falls, ID (US); Laidig Systems, Inc., Mishawaka, IN (US)

(21) Appl. No.: 11/766,637

(22) Filed: Jun. 21, 2007

Related U.S. Application Data
(60) Provisional application No. 60/868,315, filed on Dec. 1, 2006.

(51) Int. Cl. B65G 65/30

(52) U.S. Cl. 414/133; 137/561 R; 198/523; 414/808

(57) ABSTRACT

A reclaiming system for use with bulk material includes a storage structure, an elongated mechanical reclaimer, and an aeration system for delivering a pressurized gas into bulk material located within the storage structure. The storage structure comprising a floor having a perimeter wall upstanding therefrom, the floor and perimeter wall bounding a chamber adapted to hold bulk material, the floor having a passageway formed thereon. The elongated mechanical reclaimer has a first end and an opposing second end, the first end being disposed adjacent to the passageway and the second end being rotatable about the first end. The aeration system is located adjacent to the floor, adjacent to the mechanical reclaimer or is integrated into the mechanical reclaimer. By using the mechanical reclaimer in conjunction with the aeration system, the bulk material is effectively removed from the storage structure through the passageway.

### CROSS-REFERENCE TO RELATED APPLICATIONS

This application claims priority to Provisional Application Ser. No. 60/868,315, filed Dec. 1, 2006, which is hereby incorporated by specific reference.

### BACKGROUND OF THE INVENTION

1. The Field of the Invention

The present invention relates to systems, devices, and methods for storing and moving bulk material. More specifically, the present invention relates to systems, devices, and methods for storing and moving bulk material using a mechanical reclaimer in combination with aeration and fluidization.

2. The Relevant Technology

There are a variety of different storage facilities for housing bulk materials such as cement, fly ash, talc, powders, grains, etc. One typical storage facility includes a substantially enclosed housing having a floor. Centrally extending through the floor of the housing is an outlet. A conveyor belt is disposed below the floor in alignment with the outlet. During use, the outlet is initially closed and the bulk material is fed into the housing through an opening.

When it is desired to remove the bulk material from the storage facility, the outlet is opened and the bulk material flows under gravity through the outlet and onto the conveyor belt. The conveyor belt then moves the bulk material for example to a remote location, such as a loading dock, for shipment to a point of sale.

As a result of the floor of the storage facility being substantially larger than the outlet extending therethrough and due to the packing density of some material, a significant amount of stagnant bulk material can remain standing on the floor surrounding the outlet. That is, the remaining stagnant bulk material does not naturally flow into the outlet under the force of gravity. In some cases, such as where cement is being stored, the stagnant bulk material can continue build up and solidify over time which can hamper the exiting flow of the bulk material. In one approach to resolve this problem, the storage facility is periodically closed and tractors or other equipment are used to manually remove the stagnant material. This process is time consuming, labor intensive and results in a temporary loss of use of the storage facility and a loss of some of the bulk material.

In an alternative approach to the above problem, reclaim systems have been designed for use in drawing the bulk material to the outlet. A typical reclaim system comprises an auger having a first end centrally disposed in the storage facility and a second end that rotates around the first end. As the auger rotates, it draws the bulk material toward the outlet.

Mechanical reclamation may be attempted from either the top or the bottom of the material pile. Top reclamation has severe limitations in that mechanical reclaimers designed to work from the top of the bulk material typically are a) very expensive, b) limit or preclude simultaneous fill and reclamation, and c) provide last-in-first-out rather than first-in-first-out inventory management. In contrast, bottom reclamation offers simultaneous fill and reclaim, and also approaches first-in-first-out inventory management. However, bottom reclamation has its own set of problems. For example, mechanical reclaimers designed to work from the bottom of the bulk material typically must be larger and stronger than top reclaimers because the bottom mechanical reclaimer must be designed to withstand the high loads placed on it due to the weight of the piled bulk material. Furthermore, because of the heavy load and packing of the bulk material, substantially more energy is required to begin the initial rotation of the auger. This is especially true for bulk material such as cement where the bulk material can have a high packing density and where the bulk material can at least partially solidify over time. Beginning rotation of an auger under these conditions can require a large amount of energy, thereby necessitating a large motor on the auger, and can produce high torsion stresses on the auger, thereby requiring a stronger auger. As a result of the foregoing, current bottom mechanical reclaimers are very large and costly.

In an alternative approach to solving the above problem of preventing or removing stagnant bulk material, aeration and fluidization systems have been incorporated into the floors of storage structures which help to fluidize the bulk material. The use of an aeration or fluidization system requires that the floor of the storage structure be steeply sloped toward the outlet. Air-gravity conveyors are positioned on the floor which permit air to be expelled out of the floor and into the bulk material. The air helps fluidize the bulk material which enables it to more easily flow under the force of gravity into the outlet.

Although reclamation of this type is effective, it has its shortcomings. For example, sloping of the floor of a storage structure, especially a large storage structure, is very expensive and time consuming. Typically, the steeper the floor, the more expensive to build. Furthermore, for aeration or fluidization to fully solve the above problem of preventing or removing stagnant bulk material, substantially the entire floor of the storage facility needs to be covered with air-gravity conveyors. Air-gravity conveyor systems are complicated, costly, and time consuming to install. If air-gravity conveyors are installed on only a portion of the floor, stagnant bulk material will build up on the floor between the air-gravity conveyors. This results in the same problem as discussed above requiring that the storage structure to be periodically closed the stagnant bulk material to be manually removed.

Accordingly, what is needed in the art are reclamation systems that are easier and less expensive to install than prior systems and that efficiently remove substantially all of the bulk material from the floor of the storage structure so as to limit or preclude the requirement of having to manually remove stagnant bulk material from the floor of the storage structure.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is a cross sectional side view of an inventive storage facility with a mechanical reclaimer and aeration system according to one embodiment of the present invention;

FIG. 2 is a top perspective view of an air-gravity conveyor used in the aeration system shown in FIG. 1;

FIG. 3 is a schematic diagram showing the aeration system of FIG. 1;

FIG. 4 is a top plan view of the storage facility shown in FIG. 1 having eight pairs of air-gravity conveyors;

FIG. 5 is a top plan view of the storage facility shown in FIG. 1 having four pairs of air-gravity conveyors;

FIG. 5A is a top plan view of the storage facility shown in FIG. 1 having four discrete air-gravity conveyors;

FIG. 6 is a top plan view of the storage facility shown in FIG. 1 having two pairs of air-gravity conveyors;

FIG. 7 is a top plan view of the storage facility shown in FIG. 1 having one pair of air-gravity conveyors;

FIG. 8 is a partial cross sectional side view of the mechanical reclaimer shown in FIG. 1;

FIG. 9 is a partial cross sectional side view of an alternative embodiment of an inventive mechanical reclaimer having a gas delivery member attached to the mechanical reclaimer;

FIG. 10 is a cross sectional end view of the auger and gas delivery member shown in FIG. 9;

FIG. 11 is a cross sectional end view of a mechanical reclaimer and an alternative gas delivery member;

FIG. 12 is a cross sectional side view of a portion of the mechanical reclaimer and gas delivery member shown in FIG. 11;

FIG. 13 is a partial cross sectional side view of another alternative embodiment of a mechanical reclaimer and an aeration system incorporated therein;

FIG. 14 is a partial cross sectional side view of an alternative embodiment of an inventive mechanical reclaimer incorporating a drag chain conveyer as the conveying device;

FIG. 15 is a partial cross sectional side view of an alternative embodiment of an inventive mechanical reclaimer using a paddle conveyer as the conveying device; and

FIG. 16 is a partial cross sectional side view of an alternative embodiment of an inventive mechanical reclaimer using an agitator.

### DETAILED DESCRIPTION OF THE PREFERRED EMBODIMENTS

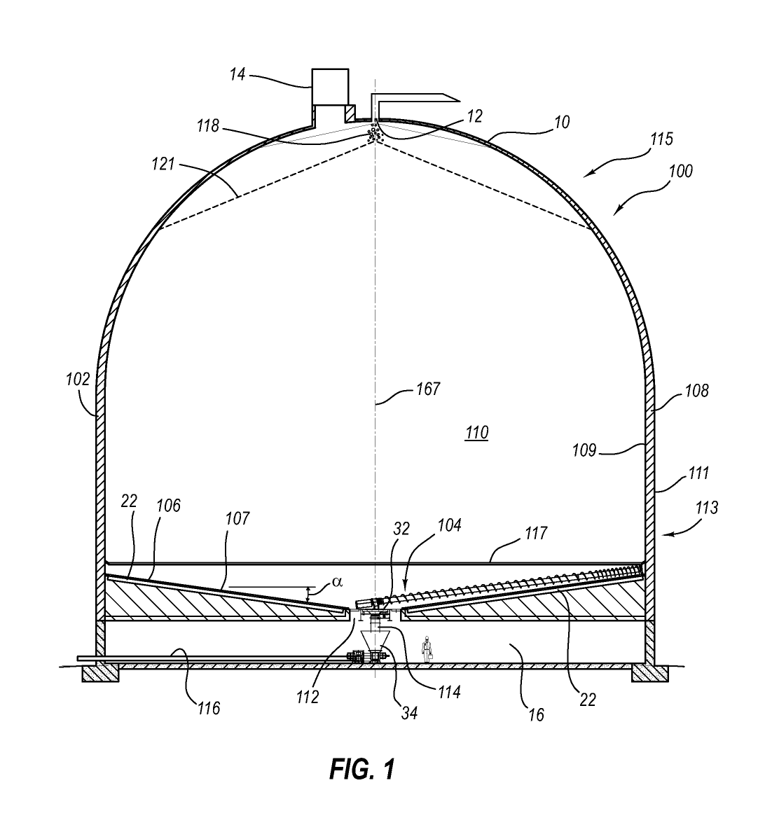

Depicted in FIG. 1 is one embodiment of an inventive storage facility 100 for use with housing bulk material and incorporating features of the present invention. Generally, storage facility 100 comprises a storage structure 102 having a mechanical reclaimer 104 disposed therein and having means for delivering a pressurized gas to the bulk material enclosed within storage structure 102.

As used in the specification and appended claims, the term “bulk material” is broadly intended to include powders, grains, sands, granulated material, and other small diameter material that is capable of flowing under the force of gravity. Bulk materials typically have an average particle diameter size less than about 4 cm, commonly less than about 2 cm, and often less than 1 cm. Common examples of bulk materials includes cement, talc, fly ash, salt, chemicals, fertilizer, minerals, bauxite, coal, sulfur, and all types of grains, including wheat, barley, corn, oats, and rice. A variety of other small diameter materials can also function as bulk materials.

As used in the specification, the terms “aerate” “aerating” or “aeration” is broadly intended to mean adding gas to the bulk material.

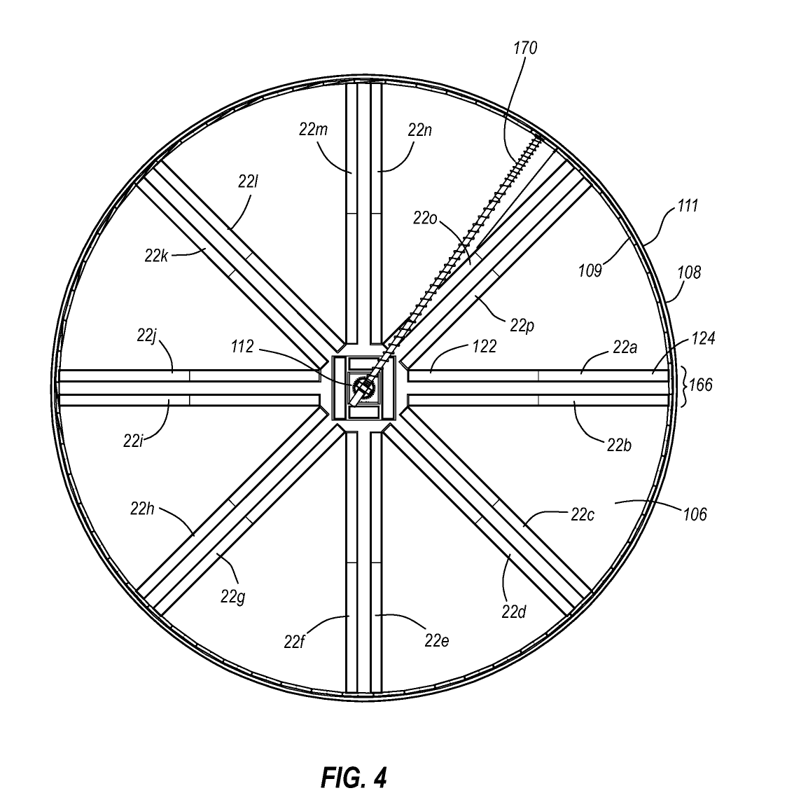

Storage structure 102 comprises a floor 106 having a top surface 107. A perimeter wall 108 upstands from and encircles floor 106. Perimeter wall 108 is shown in FIG. 4 having a substantially circular configuration when viewing from above. Other configurations can also be used. Returning to FIG. 1, perimeter wall 108 has an interior surface 109 and an exterior surface 111 that extend from a lower end 113 adjacent to floor 106 to an upper end 115. In the embodiment depicted, storage structure 102 comprises a dome wherein upper end 115 is curved and covers floor 106. Perimeter wall 108 and floor 106 bound a chamber 110. If desired, a variety of different doors can be formed on perimeter wall 108 adjacent to floor 106 to permit selective access to chamber 110 when chamber 110 is at least substantially empty of bulk material.

Storage structure 102 has a top 10 with an inlet port 12 extending through perimeter wall 108 thereat. Inlet port 12 enables a bulk material 118 to be fed from outside of storage structure 102, though inlet port 12, and into chamber 110. Bulk material 118 can be delivered to inlet port 12 through a variety of different techniques such as conveyors, pumping or other traditional delivery techniques. It is appreciated that inlet port 12 can be positioned at other locations on storage structure 102 and that there are other mechanisms for delivering bulk material 118 into chamber 110. Bulk material 118 is added until chamber 110 is filled to a desired level illustrated by dashed line 121. A dust collector 14 can also be mounted on top 10 for controlling dust within chamber 110.

In alternative embodiments, storage structure 102 can comprise a silo, hopper, bin, warehouse, or any type of enclosed or open storage structure that can store bulk material. Storage structure 102 can be comprised of reinforced concrete, metal, or other desired building materials. One method for forming a domed storage structure is disclosed in U.S. Pat. No. 4,324,704 which is incorporated herein by specific reference.

Formed below floor 106 is a passage 16. As depicted, passage 16 can extend completely across storage structure 102. In an alternative embodiment passage 16 can extend from below a defined location on floor 106, such as below the center of floor 106, to the perimeter of storage structure 102. In one embodiment, passage 16 can be located at or below ground level and can thus form a tunnel. It yet other embodiments, floor 106 can be supported above ground level by pillars, columns, or the like. In this embodiment passage 16 can be openly exposed at or above ground level.

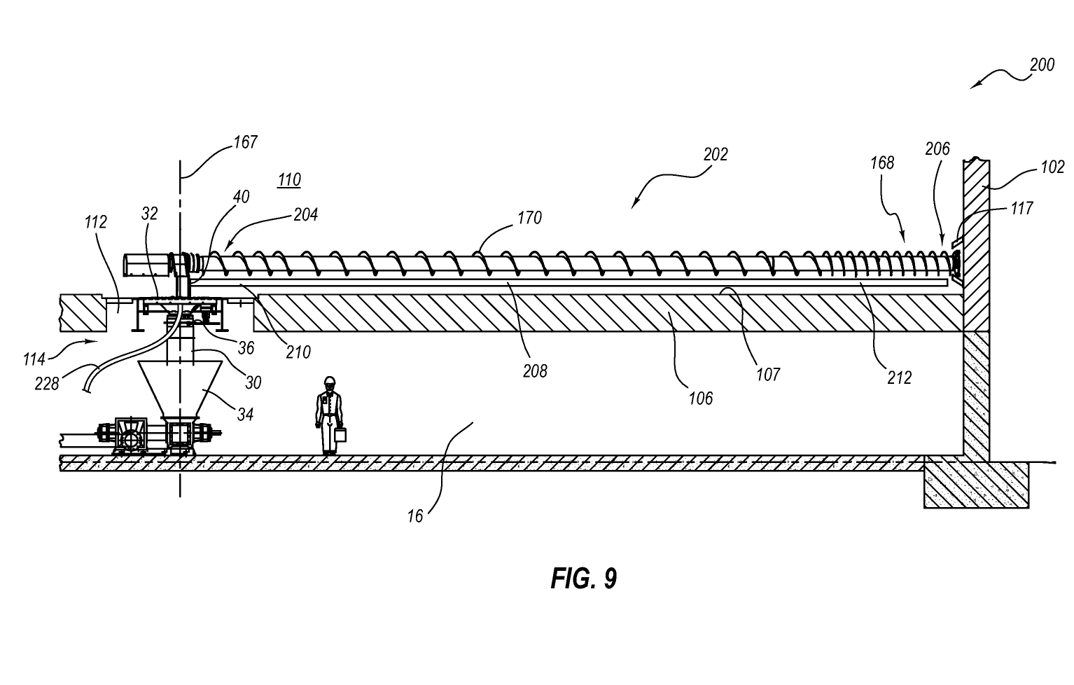

Extending through floor 106 is an outlet port 112. Outlet port 112 provides open communication between chamber 110 and passage 16. Although outlet port 112 is shown being centrally disposed on floor 106, in alternative embodiments outlet port 112 can be positioned at a variety of different locations on floor 106. Disposed within outlet port 112 is a flow regulator 114. As shown in FIG. 9, flow regulator 114 comprises a tubular housing 30 having a passageway 32 extending therethrough. A first end of passageway 32 communicates with chamber 110 of storage structure 102 and an opposing second end of passageway 32 is disposed within a funnel 34 positioned within passage 16. As a result, bulk material can flow from chamber 110, through passageway 32 and into passage 16. Flow regulator 114 also includes a valve 36 that selectively controls the flow the bulk material through passageway 32. Valve 36 can be of a variety of different types such as a plate valve or screw valve.

Returning to FIG. 1, disposed within passage 16 is a conveyor 116. Conveyor 116 has a first end disposed below flow regulator 114 being coupled with funnel 34. As a result, bulk material entering funnel 34 from flow regulator 114 is delivered to conveyor 116. Conveyor 116 extends along and out of passage 16 so that conveyor 116 can transport the bulk material out of passage 16 and to a predetermined destination for subsequent storing, treatment, shipping or the like. In one embodiment conveyor 116 can comprise a conveyor belt. In other embodiments conveyor 116 can comprise a line with pneumatic pump, an auger conveyor, or other conventional types of conveyors for moving bulk material.

Floor 106 is typically sloped downward from perimeter wall 108 to outlet port 112. Where outlet port 112 is centrally located on floor 106, top surface 107 of floor 106 has a substantially frustoconical configuration. The slope of top surface 107 of floor 106 aids in the gravitational flow of the bulk material toward flow regulator 114 and passageway 32 therein. Top surface 107 of floor 106 has a slope α relative to the horizontal typically in a range between about 5 degrees to about 60 degrees, with about 5 degrees to about 30 degrees begin more common, and about 5 degrees to about 15 degrees also being common.

In other embodiments, such as depicted in FIG. 9, top surface 107 of floor 106 can be flat and horizontal or in a range between about 0 degrees to about 25 degrees. Although other slopes can also be used, because of the unique benefits of some features of the present invention, floor 106 can be made at a much lower slope than many conventional storage structures while still enabling storage structure 102 to be substantially and efficiently emptied of bulk material 118. The ability to form floor 106 with a low angle slope is a significant benefit in that floors with low angle slopes are substantially easier and less expensive to build.

In one embodiment of the present invention, means are provided for delivering a pressurized gas into bulk material 118. As will be discussed below in greater detail, this means can be used for at least partially fluidizing bulk material 118 so as to help facilitate flow of bulk material 118 to passageway 32 under the force of gravity. The means for delivering a pressurized gas can also be used for aerating or fluidizing at least a potion of bulk material 118 around reclaimer 104 to enable reclaimer 104 to begin operation when reclaimer 104 is covered with bulk material 118.

One embodiment of the means for delivering a pressurized gas into bulk material 118 comprises an aeration or fluidization system 20 as depicted in FIG. 3. In general, aeration system 20 comprises an elongated air-gravity conveyor 22 coupled with a manifold 162 by a plurality of supply lines 164. Manifold 162 is also coupled with a pipe 160 that delivers a pressurized gas, such as air, nitrogen, carbon dioxide, or other type of gas to manifold 162. As depicted in FIG. 4, a plurality of air-gravity conveyors 22a-p are shown formed on floor 106. Each air-gravity conveyor 22 has a first end 122 disposed adjacent to or toward outlet port 112 and an opposing second end 124 disposed adjacent to or toward perimeter wall 108. In this regard, each air-gravity conveyor 22 projects radially outward away from outlet port 112. Although not required, air-gravity conveyors 22 can be disposed in pairs that are spaced apart but disposed in substantially parallel alignment. In this configuration if one air-gravity conveyor 22 fails, the adjacent air-gravity conveyor 22 should continue to work.

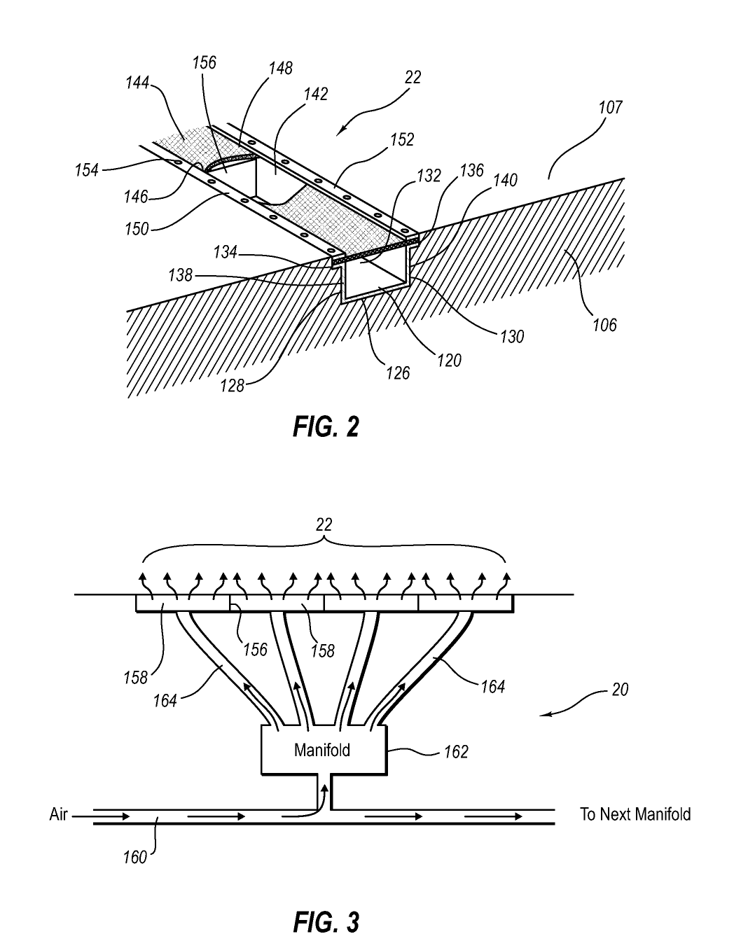

Turning to FIG. 2, in one embodiment each air-gravity conveyor 22 comprises an elongated conduit 120 that is embedded within floor 106. Alternatively, conduit 120 can be mounted on top of floor 106 or can be integrally formed on floor 106. Conduit 120 comprises a bottom wall 126 with opposing sidewalls 128 and 130 that extend upward from bottom wall 126 along opposing sides thereof Bottom wall 126 and sidewalls 128 and 130 bound a channel 132 that extends along the length of conduit 120. Flanges 134 and 136 project out from upper ends 138 and 140, respectively, of sidewalls 128 and 130. In some embodiments flanges 134 and 136 have a plurality of holes formed therein along the length of the flanges for insertion of screws or bolts. In some embodiments the holes are threaded.

Channel 132 communicates with the exterior through an elongated opening 142 disposed between sidewalls 128 and 130 at upper ends 138 and 140. A covering 144 is disposed over opening 142 so as to cover channel 132 formed within conduit 120. Covering 144 is comprised of a gas permeable material that allows the gas that is being delivered through channel 132 to flow through the material and into bulk material 118, yet prevents bulk material 118 from flowing through covering 144 and into channel 132. In one embodiment, covering 144 comprises a flexible sheet made of PVDF lacquer coated polyester.

Covering 144 is disposed on conduit 120 such that a first edge 146 of covering 144 is disposed directly over flange 134 and a spaced apart second edge 148 is disposed directly over flange 136 between opposing ends of conduit 120. A tightening strip 150 is placed over flange 134 so that first edge 146 is sandwiched between tightening strip 150 and flange 134. A plurality of holes 154 is formed in tightening strip 150 to aid in securing covering 144 to flange 134. Screws or bolts (not shown) are inserted through holes 154 and secured into flange 134, compressing the portion of covering 144 that is between tightening strip 150 and flange 134. A tightening strip 152 is placed over and secured to flange 136 in a similar manner to secure second edge 148 of covering 144 to flange 136.

As shown in FIGS. 2 and 3, each conduit 120 comprises a plurality of conduit sections 158 that are separated by a partition 156. The partitions 156 extend between sidewalls 138 and 140 so as to prevent gas from passing between different conduit sections 158. In one embodiment conduit sections 158 can comprise a singe integral conduit having one or more partitions 156 formed thereon. In an alternative embodiment, conduit sections 158 can comprise separate and discrete sections that are laid end to end with each section 158 having a partition formed on each opposing end thereof It is appreciated that conduits 120 can come in a variety of different configurations. That is, conduits 120 need not have a square or rectangular transverse cross section but can be circular, polygonal or any other desired configuration. Furthermore, covering 144 can be made of a variety of different gas permeable materials, both flexible and rigid, and can be mounted to conduit 120 using any conventional technique such as clamp, welding, adhesive, fastener, and the like.

The present invention also includes means for delivering a gas to channel 132 of each conduit section 158. As previously discussed with regard to FIG. 3, pressurized gas flows through a pipe 160 and into manifold 162. A number of gas supply lines 164 are attached to manifold 162 and are each used to convey gas from manifold 162 to a separate conduit section 158. Although only one manifold 162 and one pipe 160 are shown, it is appreciated that many manifolds and/or pipes 160 can be used in the system. As a result of using partitions 156, should covering 144 fail over one conduit section 158, such as by being torn, the remaining conduit sections should still function normally.

Air-gravity conveyors 22 can be arranged in various arrangements according to different embodiments of the current invention. Because the current invention employs the use of a mechanical reclaimer in conjunction with means for delivering a pressurized gas in storage facility 100, (as explained in more detail below) air-gravity conveyors 22 need not cover floor 106 to the extent they are used in conventional systems. For example, in the embodiment shown in FIG. 4, sixteen air-gravity conveyors (22a-p) are shown, arranged in pairs 166 of eight.

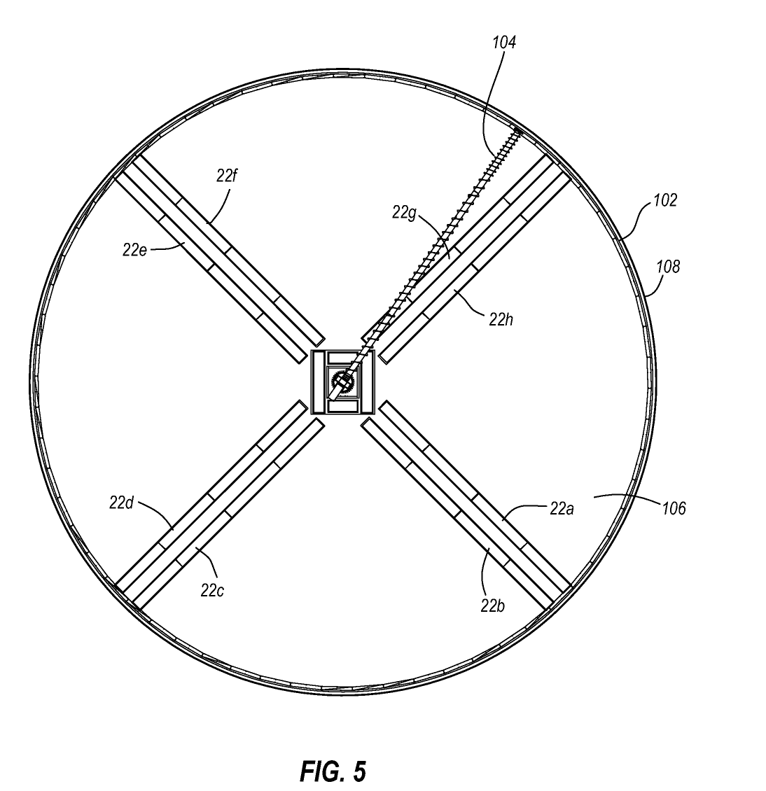

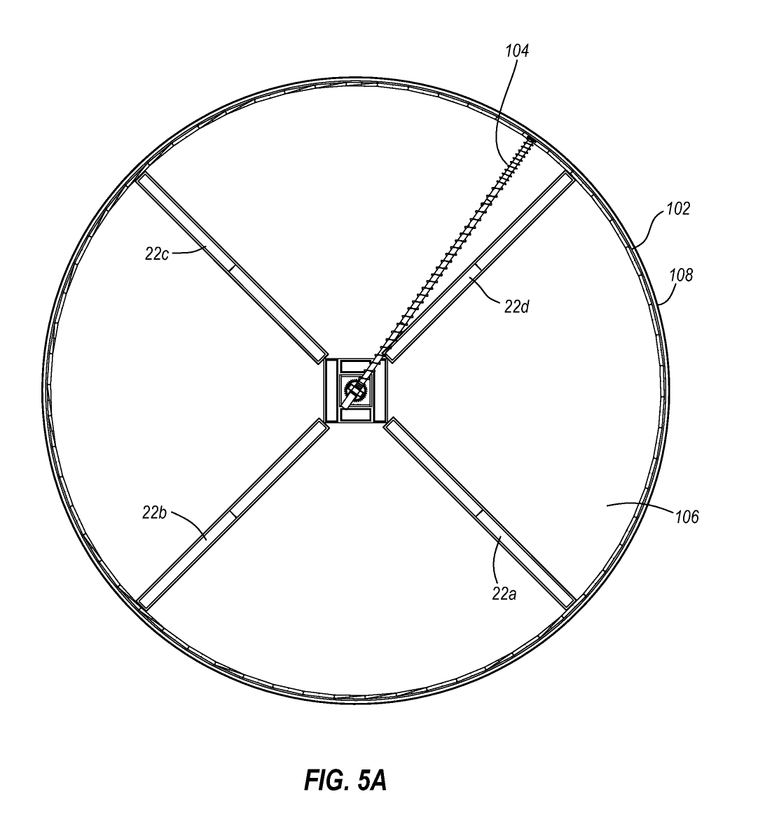

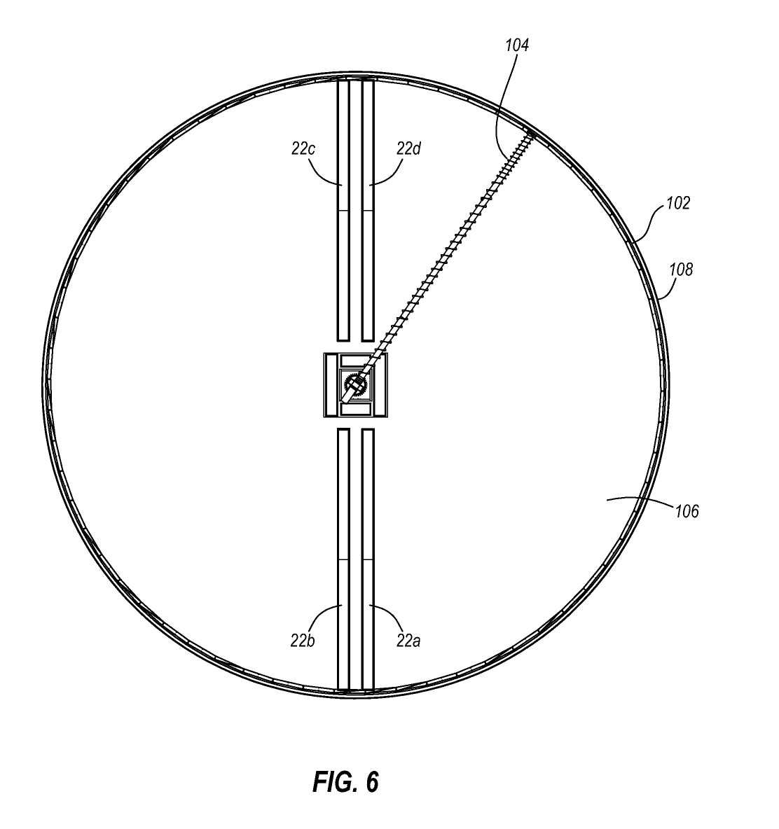

As previously discussed, the pairs of air-gravity conveyors 22 are generally arranged in a radial pattern extending away from outlet port 112 such that the first end 122 of each air-gravity conveyor 22 is disposed adjacent to outlet port 112 and the second end 124 of each air-gravity conveyor 22 generally extends linearly away from the outlet port 112. The pairs of air-gravity conveyors 22 are also generally evenly spaced apart from adjoining pairs like spokes in a wheel when viewed from above. In some embodiments more or less pairs can be used. For example, as shown in FIGS. 5, 6 and 7, embodiments having four pairs, two pairs, and a single pair of air-gravity conveyors 22 are shown, respectively, each pair being spaced apart from each other pair. It is also appreciated that air-gravity conveyors 22 need not be disposed in pairs. Rather, all air-gravity conveyors 22 can be evenly radially spaced apart. For example, FIG. 5A shows four single air-gravity conveyors 22 each radially spaced apart.

In one embodiment the number of air-gravity conveyors 22 can be in a range between about one air-gravity conveyor to about twenty air-gravity conveyors with about one air-gravity conveyor to about ten air-gravity conveyors being more common, and about one air-gravity conveyor to about six air-gravity conveyors also being common. The number of air-gravity conveyors 22 will depend on a number of factors such as the type of material to be stored, the rate at which it needs to be removed, and the extent of removal desired to be achieved by the air-gravity conveyors 22 and gravity.

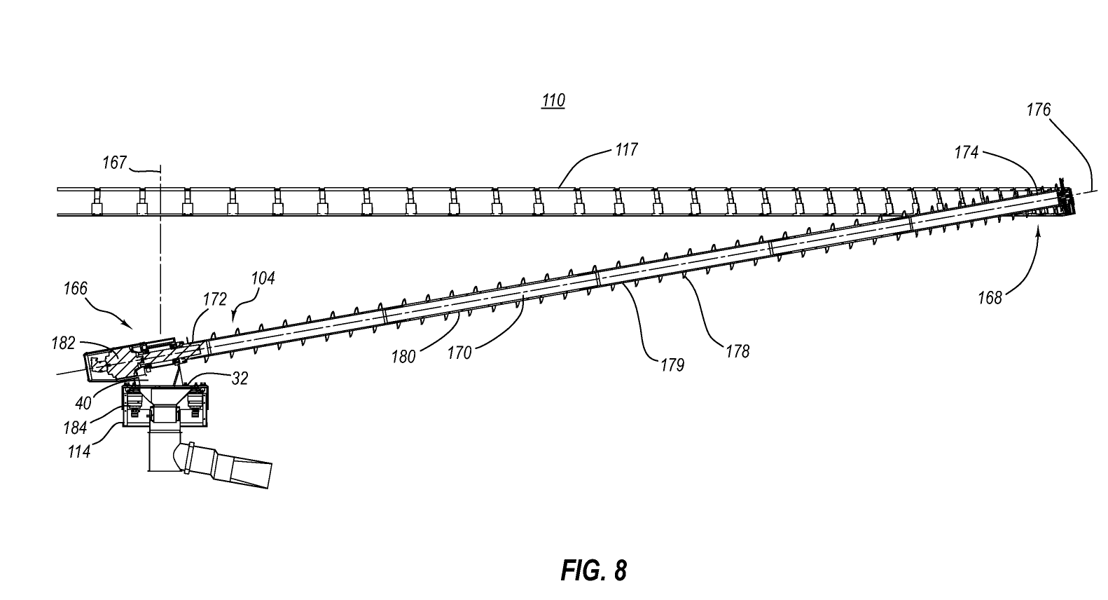

Returning to FIG. 1, to further aid in moving or removing bulk material 118 within storage structure 102, mechanical reclaimer 104 is also disposed within storage structure 102 near floor 106. Turning to FIG. 8, mechanical reclaimer 104 has a first end 166 disposed adjacent to passageway 32 and an opposing second end 168. As discussed below in greater detail, first end 166 is rotationally attached to floor 106, either directly or through flow regulator 114 so that second end 168 can rotate about first end 166, thereby allowing mechanical reclaimer 104 to revolve about a vertical axis 167 (FIG. 1). That is, mechanical reclaimer 104 can revolve about vertical axis 167 during operation of mechanical reclaimer 104.

A track 117 is mounted to perimeter wall 108 near floor 106 and encircles chamber 110. Second end 168 of mechanical reclaimer 104 is configured to movably couple to track 117. Accordingly, as mechanical reclaimer 104 revolves about vertical axis 167, a portion of second end 168 remains movably engaged with track 117. Many types of coupling configurations can be used, such as a wheel that rides on the track, a protrusion that slides on the track, or any other type of track system. Mechanical reclaimer 104 is configured to remain above floor 106 and air-gravity conveyors 22 as mechanical reclaimer 104 revolves within storage structure 102. By coupling mechanical reclaimer 104 to track 117, track 117 also prevents second end 168 of mechanical reclaimer 104 from riding upward within storage structure 102 as mechanical reclaimer 104 engages the bulk material.

With reference to FIG. 8, mechanical reclaimer 104 more specifically comprises a hub 40 that is rotatably mounted on flow regulator 114. In an alternative embodiment hub 40 can be rotatably mounted to floor 106. Mechanical reclaimer 104 is configured to convey or agitate bulk material so that the bulk material flows toward passageway 32 and out of chamber 110. Towards this end, mechanical reclaimer 104 includes means for conveying or agitating bulk material 118. In the embodiment depicted, the means for conveying comprises an elongated auger 170 having a first end 172, an opposing second end 174, and a central longitudinal axis 176 extending therebetween.

Auger 170 comprises a shaft 179 having an exterior surface 180. A screw blade 178 is helically wound about shaft 179 and outwardly projects from outer surface 180. First end 172 of auger 170 is rotatably mounted to hub 40 so that auger 170 can rotate about longitudinal axis 176. A reclaim motor 182 is also mounted on hub 40 and is coupled with first end 172 of auger 170. Reclaim motor 182 cause auger 170 to rotate about longitudinal axis 176. Screw blade 178 is configured such that when auger 170 rotates about longitudinal axis 176, the rotational movement of screw 178 causes bulk material 118 to flow toward passageway 32.

A pivoting motor 184 is mounted to hub 40 or flow regulator 114. Pivoting motor 184 functions to rotate hub 40 and auger 170 about vertical axis 167 and relative to flow regulator 114 as previously discussed. Reclaim motor 182 and pivoting motor 184 can operate separately or at the same time so that auger 170 can rotate about longitudinal axis 176 while mechanical reclaimer 104 revolves about vertical axis 167.

In many embodiments, mechanical reclaimer 104 is configured to be able to stop its mechanical motion (either the rotational motion about longitudinal axis 176 or the pivoting action about vertical axis 167, or both) when mechanical reclaimer 104 is disposed adjacent to one of air-gravity conveyors 22. This enables mechanical reclaimer 104 to be selectively parked over a select air-gravity conveyor 22. Examples of mechanical reclaimers that can be used in association with the present invention are available from Laidig Systems, Inc. out of Mishawaka, Ind.

It is appreciated that storage facility 100 can be configured to operate in a variety of different ways. By way of example and not by limitation, in one embodiment storage facility 100 can be designed so that the majority of the bulk material is removed from chamber 110 through the use of gravity and air-gravity conveyors 22. The remaining bulk material can then be removed with the assistance of mechanical reclaimer 104. Specifically, when it is desired to remove bulk material 118 from chamber 110, flow regulator 114 is selectively opened a desired amount to allow bulk material 118 to flow therethrough under the force of gravity and onto conveyor 116, as noted above. To assist in the free flow of bulk material to and out of flow regulator 114, a pressurized gas, such as air, nitrogen, carbon dioxide, or other type of gas is delivered to the plurality of radially outwardly projecting air-gravity conveyors 22. The gas exiting out through air-gravity conveyors 22 helps fluidize the bulk material 118 adjacent thereto, thereby decreasing the packing density and helping the bulk material to freely flow down to and out of flow regulator 114.

The above process continues until the free flow of bulk material 118 stops. Typically, substantially all of bulk material 118 directly above air-gravity conveyors 22 is removed from chamber 110. However, a remainder of bulk material 118 exists in generally pie shaped segments at locations between adjacent air-gravity conveyors 22. In general, the amount of remaining bulk material 118 depends on the number and size of air-gravity conveyors 22 and the angle of floor 106, i.e., the steeper the floor 106, the more bulk material that naturally flows out through flow regulator 114 under the force of gravity.

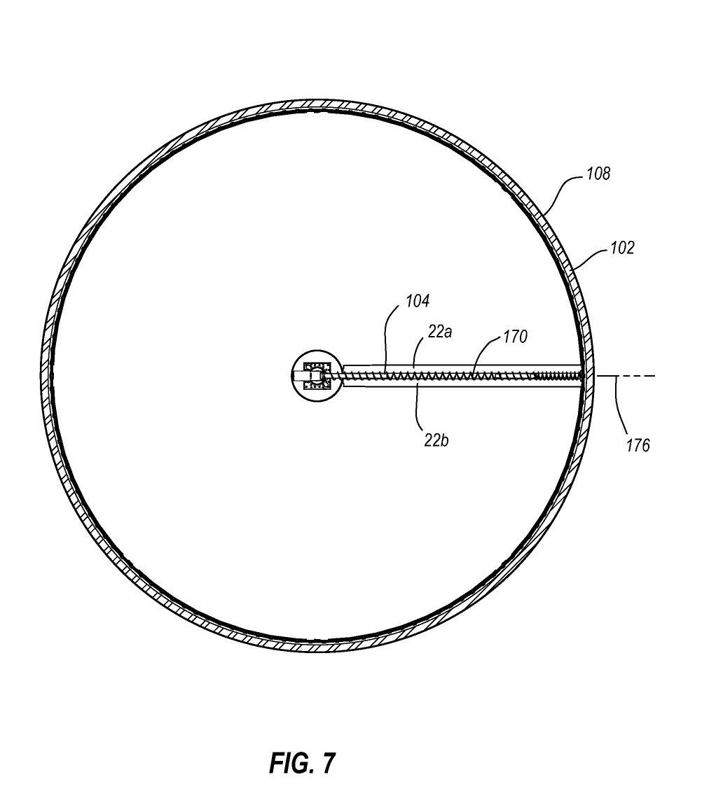

To remove the remaining bulk material 11 8, mechanical reclaimer 104 is operated. Specifically, as depicted in FIG. 7, during non-use mechanical reclaimer 104 is positioned so that auger 170 is disposed over or directly adjacent to an air-gravity conveyor 22. As a result, substantially all of the bulk material 118 is removed from off of auger 170, thereby making it easy to begin annular rotation of auger 170 about longitudinal axis 176 with use of a relatively small or lower powered reclaim motor 182 (FIG. 8). By removing as much bulk material 118 as possible from above mechanical reclaimer 104, the forces acting on mechanical reclaimer 104 are minimized, thereby alleviating many of the packing density problems.

If needs be, air-gravity conveyors 22 can continue to be operated so as to aerate or fluidize the bulk material around auger 170 to further ease in the start up of auger 170. Once auger 170 has begun rotation about longitudinal axis 176, pivoting motor 184 is used to being rotation of auger 170 about vertical axis 167. Because the remaining bulk material is at the bottom of chamber 110 and is not disposed over an air-gravity conveyor 22, the remaining bulk material will often have an increased packing density. Mechanical reclaimer 104 functions to agitate or break up the remaining bulk material 118. This enables the loosened bulk material to freely flow into passage 32 of flow regulator 114. Mechanical reclaimer 104 also functions to draw the bulk material 114 to flow regulator 114. Accordingly, as auger 170 passes over floor 106, mechanical reclaimer 104 ensures that floor 106 is substantially cleaned of all remaining bulk material without anyone having to manually enter the chamber 110.

The above combination of using both an aeration or fluidization system and a mechanical reclaimer achieves a number of benefits. For example, because any remaining bulk material will be removed by mechanical reclaimer 104, the number of air-gravity conveyors 22 can be decreased and/or the slope of floor 106 can be decreased. Both of these changes provide substantial savings in both cost and production time. Furthermore, because air-gravity conveyors 22 are used to at least partially uncover auger 170 and/or aerate the bulk material disposed adjacent thereto, mechanical reclaimer 104 can be used with a smaller motor than if the mechanical reclaimer was designed to independently remove the bulk material. Furthermore, the combination of the aeration or fluidization system and mechanical reclaimer ensures that substantially all of the bulk material can be frequently removed from chamber 110. This will ensure that stagnant bulk material is not perpetually retained in chamber 110. Stagnant bulk material can harden and build up to such an extent that it can hamper proper free removal of the bulk material and can become difficult to remove.

In a second mode of operation, it is appreciated that mechanical reclaimer 104 can be used to remove bulk material 118 even when chamber 110 is substantially full of bulk material and mechanical reclaimer 104 is completely covered by the bulk material. For example, by again positioning mechanical reclaimer over or adjacent to an air-gravity conveyor 22, the air-gravity conveyor can be operated to aerate or fluidize the bulk material adjacent to the mechanical reclaimer. Once the packing density of the bulk material around the mechanical reclaimer is decreased, the mechanical reclaimer can then be more easily started, i.e., rotation of auger 170 about longitudinal axis 176. The initial starting of rotation of auger 170 is the most difficult part and takes the most energy. Once auger 170 has started rotation, substantially less energy is required to maintain rotation. Thus, in this type of operation the size of motor 182 and the size of auger 170 are primarily dependent on the amount of energy needed to initially start rotation of auger 170. By using air-gravity conveyor 22 to aerate or fluidize the bulk material around auger 170, less energy is required to initially start rotation of auger 170. As a result, a smaller motor 182 and lighter auger 170 can be used.

Once auger 170 is started, mechanical reclaimer 104 draws the bulk material toward flow regulator 114 and passageway 32 for removal from chamber 110. Mechanical reclaimer can initially be retained over air-gravity conveyor 22 as the bulk material is drawn down above it or auger 170 can be rotated away from air-gravity conveyor 22. Once auger 170 is started, operation of air-gravity conveyor 22 can be retained to further assist in aerating or fluidizing the bulk material, especially when auger 170 is retained over air-gravity conveyor 22, or air-gravity conveyor 22 can be turned off Using this technique, mechanical reclaimer 104 can be used to substantially remove all of the bulk material from chamber 110 even when the floor 106 is flat and substantially horizontal and when only a single air-gravity conveyor 22 is used. In still other embodiments, it is appreciated that the air-gravity conveyors and mechanical reclaimer can be used in any desired combination or any desired order and with a floor of any desired slope. For example, mechanical reclaimer 104 can be used before, during, or after bulk material 118 is allowed to freely flow out through flow regulator 114 under the force of gravity and can be used continuously or periodically with one or more of the air-gravity conveyors 22.

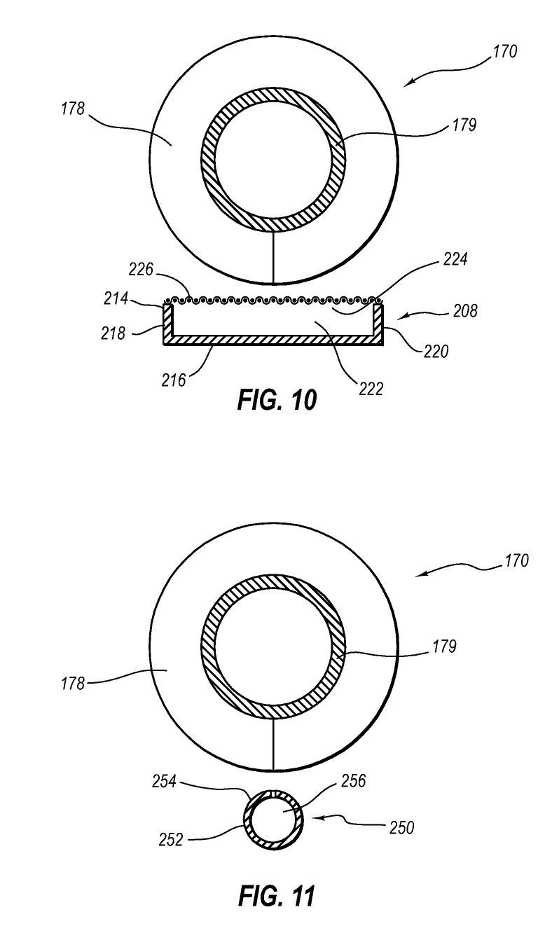

In the embodiment previously discussed herein, the means for delivering the pressurized gas has been disposed on and fixed to floor 106 of storage structure 102. Depicted in FIGS. 9 and 10 is an alternative embodiment of a storage facility 200 incorporating features of the present invention. Like elements between storage facility 100 and storage facility 200 are identified by like reference characters. Similar to storage facility 100, storage facility 200 comprises storage structure 102 having an elongated mechanical reclaimer 202 and means for delivering a pressurized gas to the bulk material enclosed within storage structure 102. Similar to mechanical reclaimer 104, mechanical reclaimer 202 has a first end 204 disposed adjacent to passageway 32 and a second end 206 spaced apart and extending away from first end 204. Mechanical reclaimer 202 can also revolve about vertical axis 167.

As opposed to air-gravity conveyors 22 that are fixedly disposed adjacent to or embedded within floor 106 in reclaiming system 100, the means for delivering the pressurized gas in storage facility 200 is configured to move with mechanical reclaimer 202 so as to remain adjacent to mechanical reclaimer 202 as second end 206 of mechanical reclaimer 202 rotates about first end 204 of mechanical reclaimer 202.

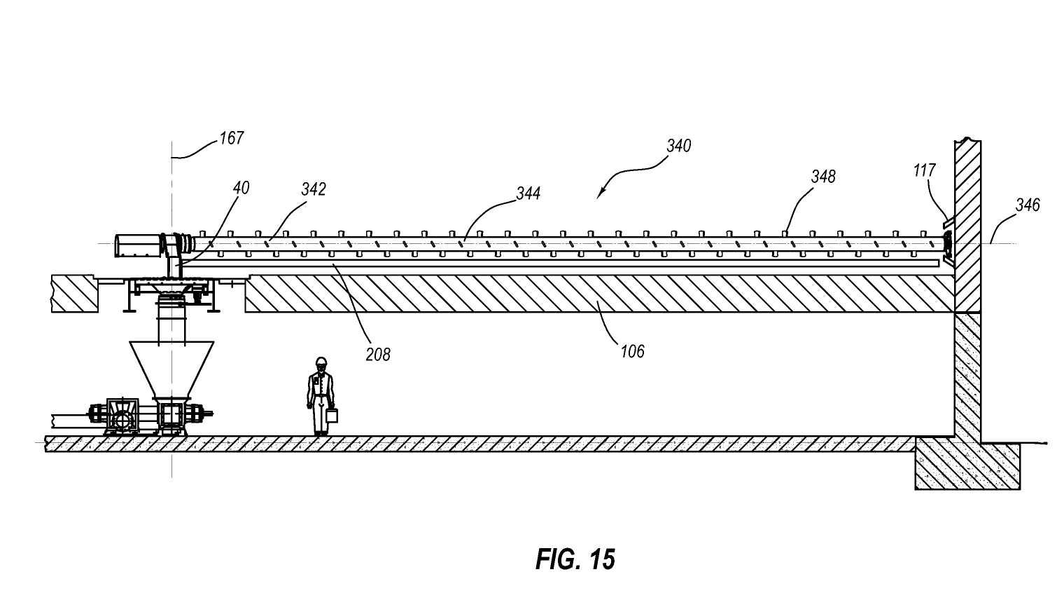

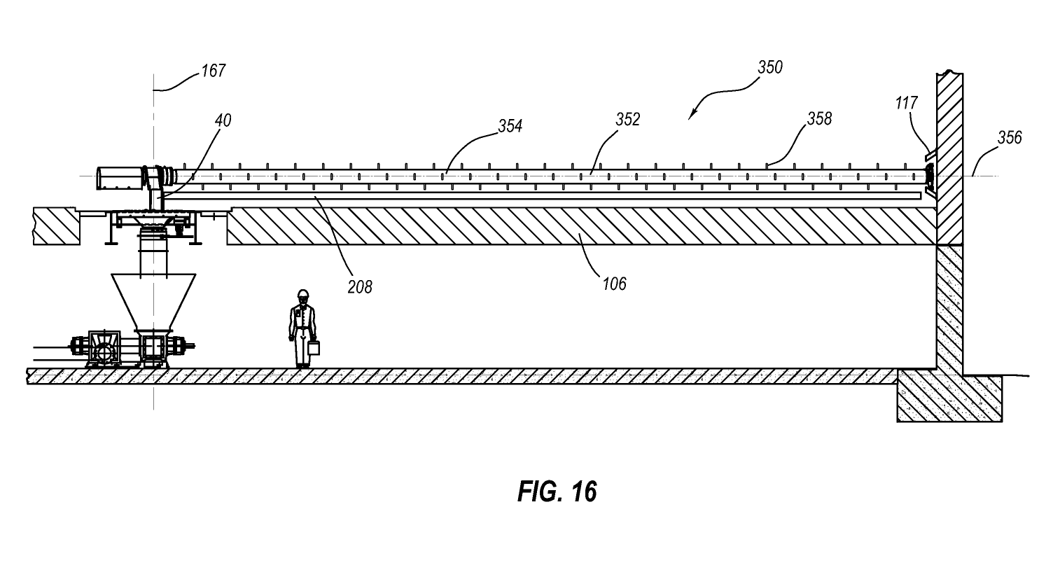

In the embodiment depicted, the means for delivering the pressurized gas comprise an elongated, hollow gas delivery member 208 having a first end 210 attached to hub 40 of mechanical reclaimer 202 and a second end 212 extending away from first end 210. Gas delivery member 208 extends generally longitudinally along auger 170 toward second end 168 of auger 170. Except for where it attaches to mechanical reclaimer 202, gas delivery member 208 is typically spaced apart from mechanical reclaimer 202 along the length of gas delivery member 208. In one embodiment, second end 212 of gas delivery member 208 attaches to second end 168 of auger 170 using a spacer 229 (see FIG. 15) to help gas delivery member 208 stay spaced apart from mechanical reclaimer 202 and to ensure that gas delivery member 208 remains adjacent to auger 170 along the entire length of gas delivery member 208 as auger 170 rotates about vertical axis 167. In another embodiment, second end 212 of gas delivery member 208 is configured to movably couple to a track 230 (see FIG. 16), disposed directly below track 117. Accordingly, as gas delivery member 208 revolves about vertical axis 167 with auger 170, a portion of second end 212 remains movably engaged with track 230. Track 230 can be integrated with track 117 or can be a separate member. As shown in FIG. 10, gas delivery member 208 is disposed generally below auger 170, although gas delivery member 208 can alternatively be disposed to the side of mechanical reclaimer 202 if so desired. A gas line 228 couples with gas delivery member 208 through hub 40 and delivers a pressurized gas to thereto.

In the embodiment shown, gas delivery member 208 comprises a conduit 214 similar in function to conduit 120. Conduit 214 has a bottom wall 216 with opposing sidewalls 218 and 220 that upwardly extend therefrom. Bottom wall 216 and sidewalls 218 and 220 bound a channel 222 that extends along the length of conduit 214 from first end 210 to second end 212. Unlike channel 132, the channel 222 of conduit 214 has no section dividers. Channel 222 of conduit 214 communicates with an opening 224 disposed between sidewalls 218 and 220. A covering 226 is disposed over opening 224 so as to cover channel 222 formed within conduit 214. Similar to covering 144, covering 226 is comprised of a gas permeable material that allows the gas that is being delivered through channel 222 to flow through covering 226 and into bulk material 118, yet prevents bulk material 118 from flowing through covering 226 and into channel 222. In different embodiments, covering 222 can comprise a flexible sheet or a rigid member having holes formed thereon.

During use, gas is passed out of gas delivery member 208 so as to aerate the bulk material adjacent to auger 170. This enables auger 170 to be easily rotated. Gas delivery member rotates about vertical axis 167 concurrently with auger 170 so that the bulk material adjacent to auger 170 can be continually aerated.

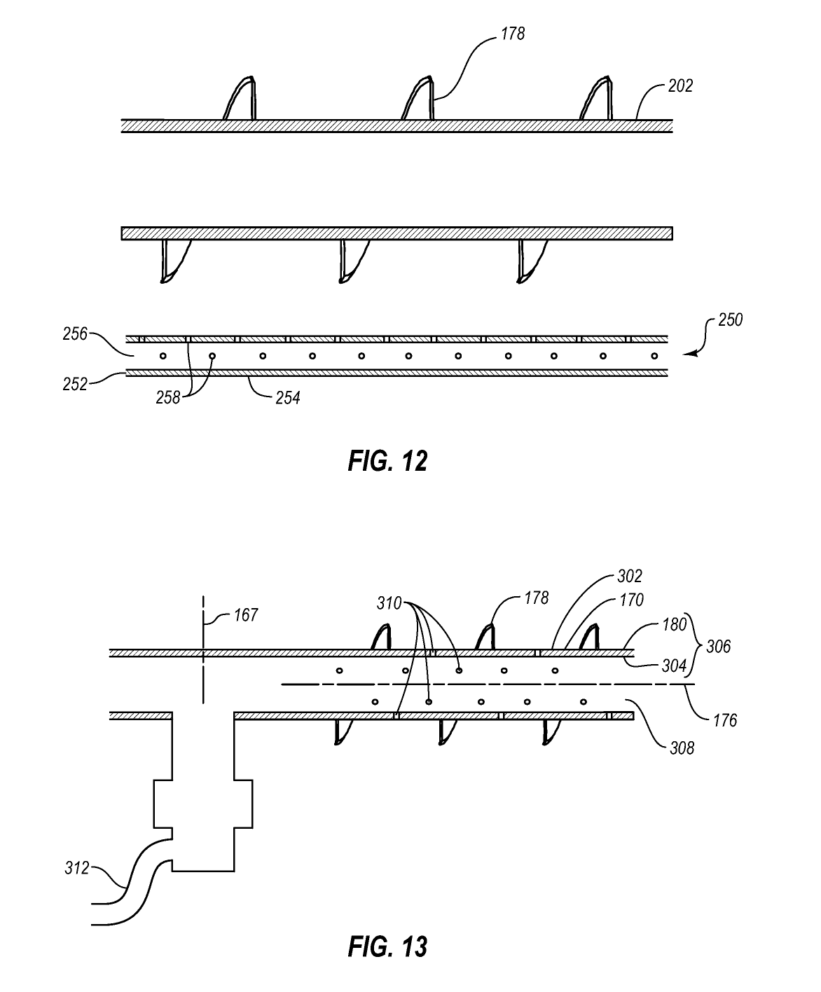

FIGS. 11 and 12 depict an alternative embodiment of a gas delivery member 250 that can be used with mechanical reclaimer 202. Like elements between gas delivery member 250 and gas delivery member 208 are identified by like reference characters. As opposed to comprising an open conduit with permeable cover, gas delivery member 250 comprises an elongated hollow tube 252 having an annular sidewall 254 extending from first end 210 to second end 212. Sidewall 254 bounds a channel 256 that extends along the length of tube 252 from first end 210 to second end 212. A plurality of holes 258 extend through sidewall 254 along the length of tube 252 so as to communicate between channel 256 and the outside of tube 252. The holes 258 are sized such that pressurized gas can flow through holes 258 and into bulk material 118, but bulk material 118 is prevented from flowing through the material and into channel 256. Gas line 228 (FIG. 9) is used to deliver pressurized gas to channel 256 of tube 252. The pressurized gas travels through channel 256 and passes through the plurality of holes 258 and into bulk material 118. In yet another alternative, tube 252 can simply be made of a porous material.

Mechanical reclaimer 202 and gas delivery members 208 and 250 operate in conjunction with one another to remove bulk material 118 somewhat similar to the manner described previously with regard to mechanical reclaimer 104 and the means for delivering the pressurized gas, except that the means for delivering the pressurized gas revolves about vertical axis 167 as mechanical reclaimer 202 revolves about vertical axis 167 so as to remain adjacent to mechanical reclaimer 202 as mechanical reclaimer 202 revolves.

During operation, a pressurized gas, such as pressurized air, nitrogen, carbon dioxide, or other type of gas, is delivered through gas delivery line 228 to gas delivery member 208 or 250 and into a portion of bulk material 118, as described above. The infusion of the gas fluidizes and thereby decreases the packing density of the portion of bulk material 118 into which the gas flows. Because gas delivery member 208 or 250 remains adjacent to mechanical reclaimer 202, the portion of bulk material 118 adjacent to mechanical reclaimer 202 is always the portion of bulk material 118 into which the gas is infused. Thus, the packing density of the bulk material adjacent to mechanical reclaimer 202 is reduced.

The operation of mechanical reclaimer 202 is initiated after the delivery of pressurized gas into the bulk material 118 has been initiated so as to take advantage of the lower packing density. This reduces the load on mechanical reclaimer 202 thus reducing the cost and complexity of the system. Once mechanical reclaimer 202 has begun operating, the delivery of pressurized gas into bulk material 118 can continue or can be terminated.

One advantage with this alternative embodiment is that the operator can stop the operation of mechanical reclaimer 202 at any time and at any position within storage structure 102 without worrying about overcoming the high packing density caused by the stoppage or whether mechanical reclaimer 202 is being stopped over an air-gravity conveyor 22. By having gas delivery member 208 or 250 revolve with mechanical reclaimer 202, gas delivery member 208 or 250 is in a position to be able to fluidize the bulk material adjacent to mechanical reclaimer 202 to lower the packing density before restarting the mechanical operation of mechanical reclaimer 202 regardless of the position of mechanical reclaimer 202.

Depicted in FIG. 13 is another alternative embodiment of a mechanical reclaimer 302 and means for delivering a pressurized gas to the bulk material enclosed within storage structure 102. In this embodiment, auger 170 has an inner surface 304 and an opposing outer surface 180 that extend along longitudinal axis 176. Inner surface 304 and outer surface 180 together forming an annular auger sidewall 306. Inner surface 304 bounds a channel 308 that extends longitudinally through auger 170 from first end 172 to second end 174. A plurality of holes 310 extend transversally through sidewall 306 at locations along the length of auger 170 so as to communicate between channel 306 and the outside of auger 170. The holes 310 are sized such that pressurized gas can flow through holes 310 and into bulk material 118, but bulk material 118 is prevented from flowing through the holes 310 and into bore 306. During operation, pressurized gas is delivered through an gas delivery line 312 to channel 308. The pressurized gas travels through channel 308 and passes through the plurality of holes 310 and into the bulk material 118.

Similar to the method of operation using mechanical reclaimer 202, the means for delivering the pressurized gas using mechanical reclaimer 302 revolves about vertical axis 167 as mechanical reclaimer 302 also revolves about vertical axis 167.

During operation, a pressurized gas, such as pressurized air, nitrogen, carbon dioxide, or other type of gas, is delivered through gas delivery line 312 to channel 308 and into the portion of bulk material 118 adjacent to mechanical reclaimer 302, as described above. Similar to the method of mechanical reclaimer 202, the infusion of the gas aerates or fluidizes and thereby decreases the packing density of the portion of bulk material 118 adjacent to mechanical reclaimer 302. Similar to the operation of previously discussed embodiments, the operation of mechanical reclaimer 302 can be initiated after the delivery of pressurized gas into bulk material 118 has been initiated so as to take advantage of the lower packing density. This reduces the load on mechanical reclaimer 302 thus reducing the cost and complexity of the system. Once mechanical reclaimer 302 has begun operating, the delivery of pressurized gas into bulk material 118 can continue or can be terminated.

Similar to mechanical reclaimer 202, one advantage with this alternative embodiment is that the operator can stop the operation of mechanical reclaimer 302 at any time and at any location within storage structure 102 without worrying about having to overcome the high packing density caused by the stoppage or whether mechanical reclaimer 302 is disposed over an air-gravity conveyor. By integrating the gas delivery apparatus into auger 170, the corresponding means for delivering the pressurized gas will always revolve with mechanical reclaimer 302 and the means for delivering the pressurized gas will be in a position to be able to aerate or fluidize the bulk material adjacent to mechanical reclaimer 302 to lower the packing density before restarting the mechanical operation of mechanical reclaimer 302 regardless of the position of mechanical reclaimer 302.

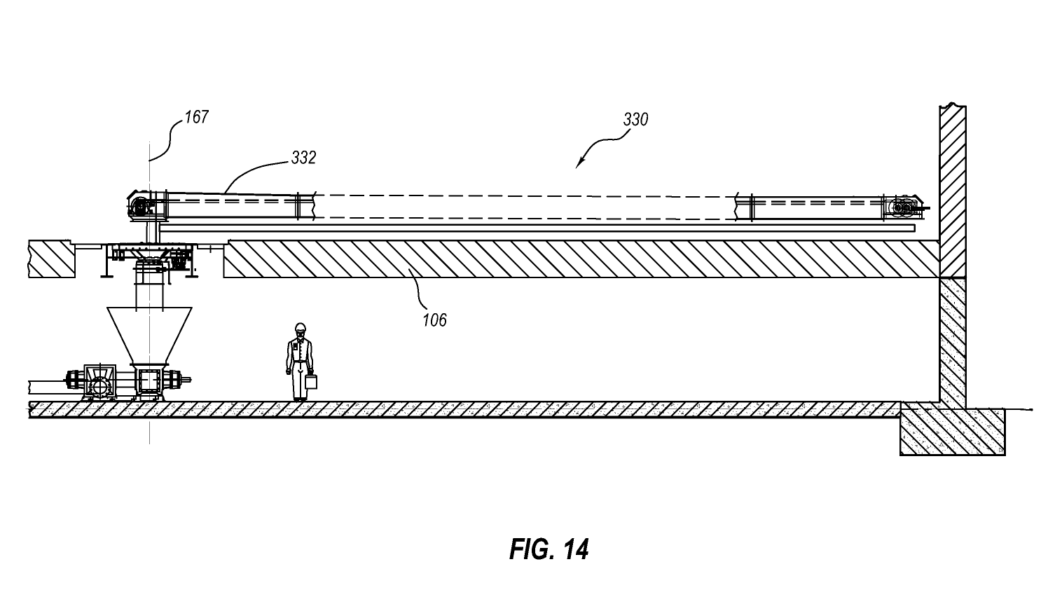

Although the previously described embodiments have included an auger as the portion of the mechanical reclaimer that conveys bulk material toward passageway 32, it is appreciated that other types of conveying devices can alternatively be used. For example, depicted in FIG. 14 is an alternative embodiment of a mechanical reclaimer 330 in which a drag conveyer 332 as is known in the art is used in place of the auger 170 as the conveying device. Drag conveyer 332 comprises an elongated conveyer member 331 that is mounted to hub 40. A drag line 334, such as a chain, extends from a first end 335 to a second end 336 of conveyer member 331, loops over a pulley 337 or similar device at second end 336 and extends back to first end 335 so as to form a loop. A motor 338 is attached to drag line 334, which moves drag line 334 so as to draw the bulk material to passageway 32. A cover is typically placed over the portion of drag line 334that is moving away from motor 338 so that the bulk material will not be moved away from passageway 32.

Alternatively, depicted in FIG. 15 is another alternative embodiment of a mechanical reclaimer 340 in which a paddle conveyer 342 as is known in the art is used in place of the auger 170 as the conveying device. Paddle conveyer 342 comprises an elongated shaft 344 that is mounted to hub 40 so as to selectively rotate about a central longitudinal axis 346. A plurality of spaced apart paddles 348 radially outwardly project from shaft 344 along the length of shaft 344. Paddles 348 are sloped so that paddles 348 draw the bulk material to passageway 32. It is also appreciated that other conveying or reclaiming devices known in the art can alternatively be used as a mechanical reclaimer.

As with auger 170, drag conveyer 332 and paddle conveyer 342 can selectively rotate about vertical axis 167 and can be used separately with each of the different embodiments of the means for delivering a pressurized gas described previously. That is, similar to auger 170, drag conveyer 332 and paddle conveyer 342 can be used in conjunction with air-gravity conveyors 22, gas delivery members 208 or 250, or by incorporating holes directly thereon through which pressurized gas can be dispensed. It is also appreciated that the various alternative mechanical reclaimers disclosed herein can also be used with a flat floor, as shown, or with a sloped floor.

In some embodiments, instead of using a conveying device such as an auger, a drag conveyer, or a paddle conveyer to convey the bulk material toward outlet port 112, an agitator can be used to simply agitate or break up the bulk material so that gravity can then guide the material toward outlet port 112. For example, depicted in FIG. 16 is another alternative embodiment of a mechanical reclaimer 350 in which an agitator 352 as is known in the art is used in place of a conveying device. Agitator 352 comprises an elongated shaft 354 that is mounted to hub 40 so as to selectively rotate about a central longitudinal axis 356. A plurality of spaced apart prongs 358 radially outwardly project from shaft 354 along the length of shaft 354. As noted above, agitator 352 simply agitates bulk material 118 as it rotates and allows gravity to move bulk material 118 toward passageway 32. Agitator 352 does not itself necessarily draw the bulk material toward outlet port 112. As with the conveying devices previously described, agitator 352 can be used with any of the embodiments described for the means for delivering the pressurized gas.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A reclaiming system for use with bulk material, the system comprising:
a storage structure comprising a floor having a perimeter wall upstanding therefrom, the floor and perimeter wall bounding a chamber adapted to hold bulk material, the floor having a passageway formed thereon through which the bulk material can pass out of the chamber;
an elongated mechanical reclaimer having a first end and an opposing second end, the first end being disposed adjacent to the passageway formed on the floor, the second end being rotatably about the first end, the mechanical reclaimer being adapted to move bulk material disposed within the chamber; and
means for delivering a pressurized gas into bulk material located adjacent to the floor when bulk material is disposed within the chamber of the storage structure.

2. The reclaiming system as recited in claim 1, wherein the storage structure comprises a silo or a domed structure.

3. The reclaiming system as recited in claim 1, wherein the floor has a frustoconical configuration.

4. The reclaiming system as recited in claim 3, wherein the floor is sloped at an angle in a range between about 5 degrees to about 30 degrees relative to the horizontal.

5. The reclaiming system as recited in claim 1, wherein the floor is substantially horizontal or has a slope in a range between about 0 degrees to about 10 degrees relative to the horizontal.

6. The reclaiming system as recited in claim 1, wherein the means for delivering the pressurized gas comprises an air-gravity conveyor mounted or formed on the floor.

7. The reclaiming system as recited in claim 6, further comprising not more than six spaced apart air-gravity conveyors mounted or formed on the floor.

8. The reclaiming system as recited in claim 6, further comprising not more than twelve spaced apart air-gravity conveyors mounted or formed on the floor.

9. The reclaiming system as recited in claim 1, wherein the means for delivering the pressurized gas comprises:
a plurality of discrete conduits attached to, embedded within or formed on the floor, each conduit bounding a channel that communicates with an opening;
a gas permeable material covering the opening of each conduit; and
a plurality of gas supply lines, each gas supply line being connected to a corresponding one of the plurality of conduits.

10. The reclaiming system as recited in claim 9, wherein each conduit is elongated and comprises a first end and a spaced apart second end, and the conduits are arranged in pairs such that the first end of each conduit in each pair is adjacent to one another and the second end of each conduit in each pair is adjacent to one another, and wherein the pairs of conduits are arranged in a radial pattern such that the first end of each conduit in each pair is disposed adjacent to the passageway and the second end of each conduit in each pair generally extends linearly away from the passageway.

11. The reclaiming system as recited in claim 10, wherein the means for delivering the pressurized gas comprises at most eight pairs of conduits embedded within the floor.

12. The reclaiming system as recited in claim 1, wherein the mechanical reclaimer comprises: a paddle conveyer, a drag chain conveyer, or an agitator.

13. The reclaiming system as recited in claim 1, wherein the mechanical reclaimer comprises an auger, the auger being rotatable about a longitudinal axis of the auger.

14. The reclaiming system as recited in claim 1, further comprising a track mounted to the perimeter wall of the storage structure, the second end of the mechanical reclaimer being movably coupled to the track.

15. The reclaiming system as recited in claim 1, wherein at least a portion of the means for delivering the pressurized gas is integrated with the mechanical reclaimer.

16. The reclaiming system as recited in claim 15, wherein
the mechanical reclaimer comprises an auger having a longitudinal axis that extends from a first end to a spaced apart second end, the auger being rotatable about the longitudinal axis, the auger having an annular sidewall; and
wherein the means for delivering the pressurized gas comprises:
a channel defined by the sidewall of the auger and longitudinally passing through at least a portion of the auger;
a plurality of holes passing transversally through the sidewall of the auger so as to communicate between the channel and the outside of the auger; and
a gas line that passes gas into the channel so as to force gas through the plurality of holes.

17. The reclaiming system as recited in claim 1, wherein the means for delivering the pressurized gas comprises an elongated gas delivery member disposed adjacent to the mechanical reclaimer, the gas delivery member being configured to move with the mechanical reclaimer so as to remain adjacent to the mechanical reclaimer as the second end of the mechanical reclaimer rotates about the first end of the mechanical reclaimer.

18. The reclaiming system as recited in claim 17, wherein
the gas delivery member comprises:
a conduit bounding a channel that communicates with an opening; and
a gas permeable material covering the opening of the conduit,
and wherein the means for delivering the pressurized gas further comprises:
means for delivering the gas to the channel of the conduit.

19. The reclaiming system as recited in claim 17, wherein
the gas delivery member comprises:
an elongated hollow tube having an annular sidewall bounding a channel; and
a plurality of holes passing through the sidewall of the tube so as to communicate between the channel and the outside of the tube,
and wherein the means for delivering the pressurized gas further comprises:
means for delivering the gas to the channel of the tube.

20. A reclaimer system for moving bulk material, the reclaimer system comprising:
an elongated mechanical reclaimer having a first end and an opposing second end, the second end being rotatable about the first end, the mechanical reclaimer being adapted to convey or agitate bulk material;
means for delivering a pressurized gas into an area adjacent to the mechanical reclaimer, at least a portion of the means for delivering the pressurized gas being movable in concert with the mechanical reclaimer such that the portion of the means for delivering the pressurized gas moves with the mechanical reclaimer when the second end of the mechanical reclaimer rotates about the first end of the mechanical reclaimer.

21. The reclaimer system as recited in claim 20, wherein the portion of the means for delivering the pressurized gas is integrally formed with, attached to, or adjacent to the mechanical reclaimer.

22. The reclaimer system as recited in claim 20 wherein the mechanical reclaimer comprises: a paddle conveyer, a drag chain conveyer, or an agitator.

23. The reclaimer system as recited in claim 20, wherein the mechanical reclaimer comprises an auger, the auger being rotatable about a longitudinal axis of the auger.

24. The reclaimer system as recited in claim 20, wherein
the mechanical reclaimer comprises an auger having a longitudinal axis that extends from a first end to a spaced apart second end, the auger being rotatable about the longitudinal axis, the auger having an annular sidewall; and
the means for delivering the pressurized gas comprises:
a bore defined by the sidewall of the auger and longitudinally passing through at least a portion of the auger;
a plurality of holes passing transversally through the sidewall of the auger so as to communicate between the bore and the outside of the auger; and
a gas line that passes gas into the bore so as to force gas through the plurality of holes.

25. The reclaimer as recited in claim 20, wherein the portion of the means for delivering the pressurized gas comprises an elongated gas delivery member disposed adjacent to the mechanical reclaimer, the gas delivery member being configured to remain adjacent to the mechanical reclaimer as the second end of the mechanical reclaimer rotates about the first end of the mechanical reclaimer.

26. The reclaimer as recited in claim 25, wherein
the gas delivery member comprises:
a conduit bounding a channel that communicates with an opening; and
a gas permeable material covering the opening of the conduit,
and wherein the means for delivering the pressurized gas further comprises:
means for delivering the gas to the channel of the conduit.

27. The reclaimer as recited in claim 25, wherein
the gas delivery member comprises:
an elongated hollow tube having an annular sidewall bounding a bore; and
a plurality of holes passing through the sidewall of the tube so as to communicate between the bore and the outside of the tube,
and wherein the means for delivering the pressurized gas further comprises:
means for delivering the gas to the bore of the tube.

28. A method for moving bulk material out of a storage structure, the method comprising:
delivering a gas to a first portion of the bulk material to cause the first portion of the bulk material to move toward a passageway and out of the storage structure; and
operating a mechanical reclaimer adjacent to a floor of the storage structure to cause a second portion of the bulk material to move toward the passageway and out of the storage structure while the mechanical reclaimer rotates within the storage structure.

29. The method as recited in claim 28, wherein the act of delivering the gas is performed before the act of operating the mechanical reclaimer.

30. The method as recited in claim 28, wherein the act of delivering the gas is initiated before the act of operating the mechanical reclaimer is initiated and the act of delivering the gas is terminated before the act of operating the mechanical reclaimer is terminated.

31. The method as recited in claim 28, wherein the act of delivering the gas is performed concurrently with the act of operating the mechanical reclaimer, and wherein at least a portion of the first portion of the bulk material and at least a portion of the second portion of the bulk material comprise the same material.

32. The method as recited in claim 28, wherein the act of operating the mechanical reclaimer comprises rotating an auger about a longitudinal axis of the mechanical reclaimer.

33. The method as recited in claim 28, wherein the act of delivering the gas comprises delivering a nitrogen rich gas or carbon dioxide.

34. A method for moving bulk material out of a storage structure, the storage structure having a pivotable mechanical reclaimer disposed therein, the method comprising:
delivering a gas into a portion of the bulk material adjacent to the mechanical reclaimer so as to decrease a packing density of the portion of the bulk material; and
operating the mechanical reclaimer after the act of delivering the gas, thereby causing the portion of the bulk material to move toward a passageway and out of the storage structure.

35. The method as recited in claim 34, further comprising continuing to deliver the gas into the portion of the bulk material adjacent to the mechanical reclaimer after the act of operating the mechanical reclaimer has been initiated.

36. The method as recited in claim 34, further comprising terminating the act of delivering the gas after the act of operating the mechanical reclaimer has been initiated.

37. The method as recited in claim 36, further comprising continuing to operate the mechanical reclaimer after the act of terminating the gas.

38. The method as recited in claim 34, wherein the act of operating the mechanical reclaimer comprises rotating an auger about a longitudinal axis of the mechanical reclaimer.

39. The method as recited in claim 34, wherein the act of operating the mechanical reclaimer comprises rotating a paddle conveyer, a drag chain conveyer, or an agitator.

40. A reclaimer for moving bulk material, the reclaimer comprising:
an auger having a longitudinal axis that extends from a first end to a spaced apart second end, the auger being rotatable about the longitudinal axis, the auger having an annular sidewall that defines a channel that longitudinally passes through at least a portion of the auger;
a plurality of holes passing transversally through the sidewall of the auger so as to communicate between the channel and the outside of the auger; and
a gas line that passes gas into the channel so as to force air through the plurality of holes.
